(19) United States
(12) Patent Application Publication
(10) Pub. No.: US 2009/0318282 A1
(43) Pub. Date: Dec. 24, 2009

(54) Zeolite-Like Membranes from Nano-Zeolitic Particles

(75) Inventors: Anita Buekenhoudt, Geel (BE); Pierre Jacobs, Gooik (BE); Ivo Vankelecom, Blanden (BE); Johan Martens, Huldenberg (BE)

Correspondence Address: MERCHANT & GOULD PC, P.O. BOX 2903, MINNEAPOLIS, MN, 55402-0903, US

(73) Assignees: VLAAMSE INSTELLING VOOR TECHNOLOGISH ONDERZOEK N.V. (VITO), MOL (BE); K.U. LEUVEN RESEARCH & DEVELOPMENT, LEUVEN (BE)

(21) Appl. No.: 12/090,607

(22) PCT Filed: Oct. 19, 2006
(86) PCT No.: PCT/BE06/00117

§ 371 Date: Aug. 13, 2008

(30) Foreign Application Priority Data
Oct. 19, 2005 (EP) 05447235.2

(51) Int. Cl. B01J 20/28; B01J 29/04

(52) U.S. Cl. 502/4

(57) ABSTRACT

A silicate-based microporous ceramic molecular sieve membrane zeolite-like properties with an ordered stack of nanometre-sized slab-shaped building blocks having zeolite framework. A method for producing a membrane does not involve a hydrothermal treatment step, hence avoiding the formation of zeolite crystals.

### FIELD OF THE INVENTION

The present invention is related to supported microporous ceramic molecular sieve membranes and a method of manufacturing these. The synthesis of these microporous membranes involves the ordered stacking of regular nano-sized silicate-based particles having zeolite framework. A particular advantage of this membrane synthesis process is that it does not involve any hydrothermal treatment nor other type of zeolite crystal growth process. The new membranes have great application potential in molecular separations and in catalytic and adsorption processes.

### STATE OF THE ART

Fabrication of practical zeolite membranes has long been a goal of separation science. Zeolites have the principal advantages of having a crystalline structure and a defined pore size, and of having modifiable surface properties in terms of hydrophilic/organophilic nature and acidity, both linked to the chemical composition of the framework. This particular topology of zeolites and their cation exchange properties make them useful for applications of separation by selective adsorption and/or size exclusion, or for catalytic reactions. However, separation on a powdered zeolite is a batch process. In contrast, a zeolite membrane offers the possibility of separating molecules by a continuous process, which may be particularly advantageous from a technological and economical viewpoint.

Various processes for developing zeolite membranes on different supports are known in the art. From the first U.S. Pat. No. 4,699,892 (1987) up to the last patent applications e.g. US2004058799, such membranes are prepared by crystallising a film of zeolite on and/or in a porous support or on a non porous support. The crystallization of the zeolite is generally carried out by one or multiple hydrothermal treatments of a mixture that contains the precursors of the zeolite phase. Two methods can be distinguished. Either the support is immersed in a zeolite precursor solution or gel, and the ensemble is subjected to hydrothermal conditions to crystallize the zeolite (f.i. JP-A-60/129,119, U.S. Pat. No. 5,100,596, EP-A-0 481 660 and JP-A-06/321530), or the support is brought into contact with a colloidal solution, separated therefrom and hydrothermally treated separately to crystallize the zeolite from the adsorbed solution (f.i. WO-A-93/17781). Both approaches can further be subdivided based on whether or not seed crystals are used.

For a zeolite membrane to be practical, it must have a high flux and a high selectivity for the desired permeate molecule(s). Obtaining such a membrane has been difficult because of defects and interparticle voids, inherent to the hydrothermal synthesis routes known in the art. Indeed, interparticle voids are inevitably created due to the non-ideal merging of the small zeolite crystallites formed during the described synthesis routes. These interparticle voids are mesoporous non-zeolite pores showing less or no selectivity, and therefore lowering the overall performance of the zeolite membranes. It is known in the art to use multilayer coating in order to cover these interparticle voids. However, this method of synthesis in several stages, leads to the productions of thick zeolite layers with relatively low flux, and sensitive to cracking during thermal treatments of the membrane, as described in Vroon, Keizer, Verweij, J. Membr. Sci 144 65-76 (1998).

Kirschhock et al. disclose in Angew. Chem. Int. 40, 2637-2640 (2001) regular, nano-sized particles having zeolite framework, which can be generated in solution by reaction of tetraethylorthosilicate (TEOS) with quaternary ammonium hydroxides such as e.g. tetrapropylammonium (TPA), tetrabutylammonium, tetraprpylammonium and the like. Said nano-sized particles have a slab shape and occlude TPA molecules. The nanoslabs have substantially uniform size in the nm range. e.g. 4×2×1.3 nm³ or multiples thereof for the nano-sized particles with silicalite-1 framework, obtained by reaction of TPA with TEOS.

The size of the silicalite-1 nanoslabs is smaller than 5 nm. This was experimentally confirmed e.g. by Dynamic Light Scattering measurements, as disclosed by S. P. B. Kremer et al. in Studies in Surface Science and Catalysis 143, 185-192 (2002).

Said TPA containing particles can be used as building blocks and can be systematically organized in micrometre-sized, spherical particles with a concentric, layered structure, using a high amount of an appropriate surfactant as e.g. cetyltrimethylammonium bromide (CTAB) or dodecyltrimethylammonium bromide (DTAB), as is described in S. P. B. Kremer, C. E. A. Kirschhock, M. Tielen, F. Collignon, P. J. Grobet, P. A. Jacobs, J. A. Martens, Studies in Surface Science and Catalysis 143, 185-192 (2002), S. P. B. Kremer, E. A. Kirschhock, M. Tielen, F. Collignon, P. J. Grobet, P. A. Jacobs, J. A. Martens, Advance Functional Materials, 12, 286-292, (2002) and S. P. B. Kremer, C. E. A. Kirschhock, P. A. Jacobs, J. A. Martens, Comptes Rendus Chimie 8, 379-390 (2005). Hereto a solution of nano-sized particles with zeolite framework is mixed with a concentrated solution of e.g. CTAB. During the mixing, the surfactant molecules are intercalated between layers of nano-sized particles with zeolite framework (see FIG. 1a). Removal of the surfactant through calcination causes facial and lateral fusion of the nano-sized particles, leaving eventual lateral spaces between some of the nano-sized particles. These specific interparticle voids form well-defined slit-shaped super-micropores with a characteristic height of ca. 1.4 nm corresponding to about the height of one nanoslab (see FIG. 1b). After calcination to remove CTAB or DTAB and TPA molecules, N₂ adsorption reveals the presence of a dual porosity. Zeolite type micropores are present inside the stacked nanoslab particles, while super-micropores in the order of 1.4 nm are created by empty spaces between stacking particles (see FIG. 2). The material with this dual porosity was coined the name zeogrid in the publications mentioned in this paragraph. The layered stacking of the nano-sized particles is particularly proven by the low-angle XRD patterns of the micrometre-sized spherical particles, showing a low-angle peak at a d-value of around 3 nm and no high-angle Bragg-type diffraction peaks at 2θ>100 (see FIG. 3). The position of the low-angle peak corresponds to the layer repetition of 2× the height of the nano-sized particles (the nano-sized particles have two different lateral faces and stack with alternation). It was demonstrated in the mentioned publications that said organized micrometre-sized powder material can be used for the separation of alkane mixtures.

In A. M. Doyle, G. Rupprechter, N. Pfänder, R. Schlögl, C. E. A. Kirschhock, J. A. Martens, H.-J. Freund, Chemical Physics Letters, 382, 404-409 (2003), a thin film of 2-15 nm thickness was spin-coated on a crystalline silicon wafer using a solution of precursors of the above described nano-sized particles with zeolite framework, without using any surfactant. The film was subsequently subjected to a hydrothermal treatment, in order to form an ultra-thin, dense, homogeneous zeolite film, without any voids between the building particles. Calcination of the film was not performed, making the resulting film non-porous. AFM studies showed a high smoothness and overall quality of the film obtained. ED showed characteristic rings of an amorphous Si structure, proving that the stacking of precursors in this film was not well ordered.

### AIMS OF THE INVENTION

The present invention aims at providing a new supported microporous ceramic molecular sieve membrane with zeolite properties and a method of making such a membrane. This new silicate based molecular sieve membrane overcomes the drawbacks of prior art membranes and combines high flux and high selectivity, exceeding the performance of the state-of-the-art zeolite membranes. The new membranes have great application potential in molecular separations and/or in catalytic and adsorption processes.

### SUMMARY OF THE INVENTION

The present invention is related to silicate-based microporous ceramic molecular sieve membranes with zeolite-like properties and to a method of producing these membranes, as set out in the appended claims. The membranes of the invention are synthesised on a support. The support may be porous or non-porous. In case of a non-porous support, the membrane is in fact a thin film with different material and surface properties compared to the properties of the support. Therefore, the term “membrane”, as used in the present description of the invention, should also be understood as having the meaning of “film” or “layer”.

According to one aspect of the invention, there is provided a membrane comprising a support and a membrane layer coated on a surface of said support. The membrane layer comprises nanometre-sized, slab-shaped building blocks having zeolite framework. Preferably, the building blocks are arranged orderly on said surface. The orderly arrangement of the slab-shaped building blocks assumes essentially the form of a layered stack, with various layers of nanometre-sized, slab-shaped building blocks having zeolite framework. These various layers are preferably oriented essentially parallel to the surface of the support. In this orderly arrangement of the building blocks, the slab-shaped building blocks follow the roughness of the surface of the support. The layered stack of the invention is a homogeneous film formed on the support, in the sense that the building blocks are not grouped together in the form of spherical particles, as in the prior art, but form a continuous layer on the support.

Preferably, the membrane layer is characterized by a dual porosity. The nano-sized building blocks having zeolite framework comprise zeolite-like micropores, while super-micropores are created by empty spaces or voids between the building blocks. The zeolite-like micropores may have a diameter of about 5.5 angstrom. The size of the super-micropores may be on the order of 1.5 nm. According to the IUPAC classification, micropores are defined as pores not exceeding a size of 2 nm.

Preferably, the nanometre-sized slab-shaped building blocks having zeolite framework are smaller than 10 nm in size. More preferably, said building blocks are smaller than 5 nm in size.

Preferably, the membrane layer does not comprise any zeolite crystals.

According to a second aspect of the invention, there is provided a method of coating a silicate-based layer onto a support, the method comprising the steps of: mixing a solution of nanometre-sized slab-shaped building blocks having zeolite framework with an appropriate surfactant; coating the support with the obtained mixture, the concentration of said surfactant in the mixture lying in the range between 0.01 and 1 wt %; drying and calcining the coated support. The drying of the coated support is preferably carried out during a period of between 1 and 5 days. The method of the invention does not include a hydrothermal treatment step.

Preferably, the method of the invention further comprises the step of ageing said mixture. The ageing step is performed between the steps of mixing and coating. Preferably, the ageing step lasts between 1 hour and 30 days.

More preferably, the method of the invention further comprises the step of diluting said mixture. The diluting step is performed after the ageing step.

In a preferred embodiment, the method of the invention further comprises the step of subjecting the support to a pre-treatment. The support may be porous or non-porous.

### BRIEF DESCRIPTION OF THE DRAWINGS

FIG. 1a represents a schematic representation of the intercalation of surfactant molecules between layers of nano-sized articles with zeolite framework. This figure pertains to the prior art.

FIG. 1b represents a schematic representation of the stacking of nano-sized particles with zeolite framework, after calcination. The lateral fusion of the nanoslabs is not ideal, leaving lateral spaces between some of the nanoslabs. This figure pertains to the prior art.

FIG. 2 represents N₂-adsorption isotherms of calcined zeogrid powder made with surfactants CTAB and DTAB. This figure pertains to the prior art.

FIG. 3 represents Low-angle XRD pattern of calcined zeogrid powder made with surfactants CTAB and DTAB. This figure pertains to the prior art.

FIG. 4 represents a schematical representation of an innovative zeolite-like membrane with ideal stacking of the nano-sized building blocks with zeolite properties.

FIG. 5 represents the N₂-adsorption isotherm of a zeolite-like film prepared on a silicon wafer following the invention (open triangles), compared to the adsorption isotherm of zeogrid powder.

FIG. 6 represents a Low-angle XRD pattern of a zeolite-like film prepared on a silicon wafer following the method of the invention. The curves represent the pattern for a two-layer film, a one-layer film and the background signal measured for a blanco Silicon wafer.

FIG. 7 represents an SEM picture of the innovative zeolite-like membrane on flat porous support of example 1. The bar on the picture measures 1 μm.

FIG. 8 represents the Retention curve for the innovative zeolite-like membrane on tubular porous support of example 2. The curve is derived from a nanofiltration test with a mixture of small PEG molecules.

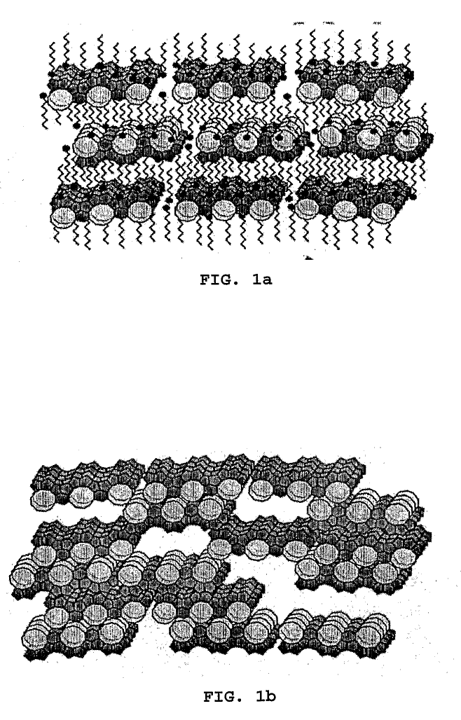

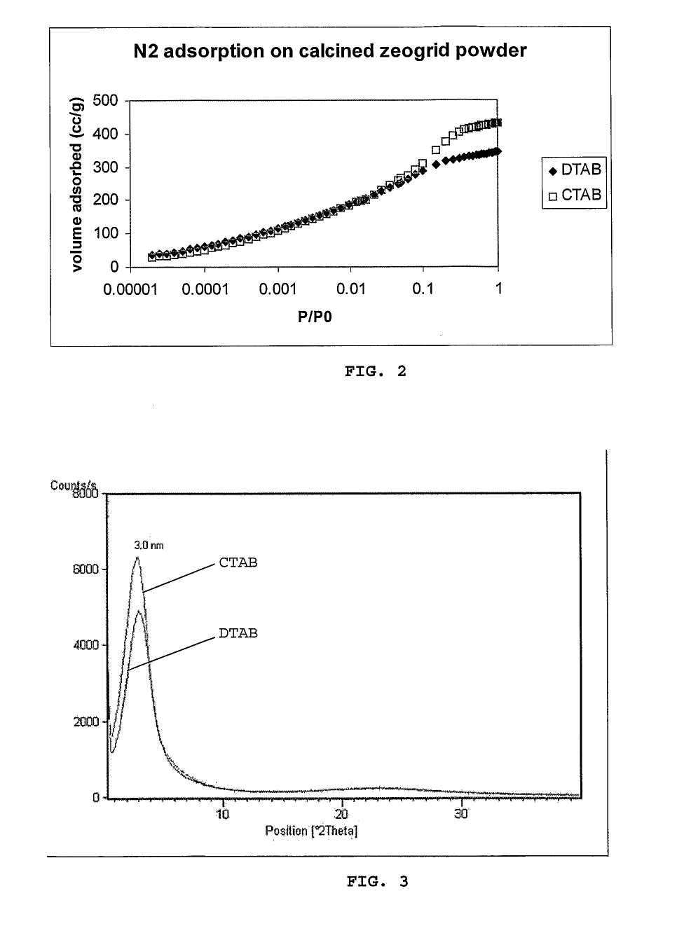

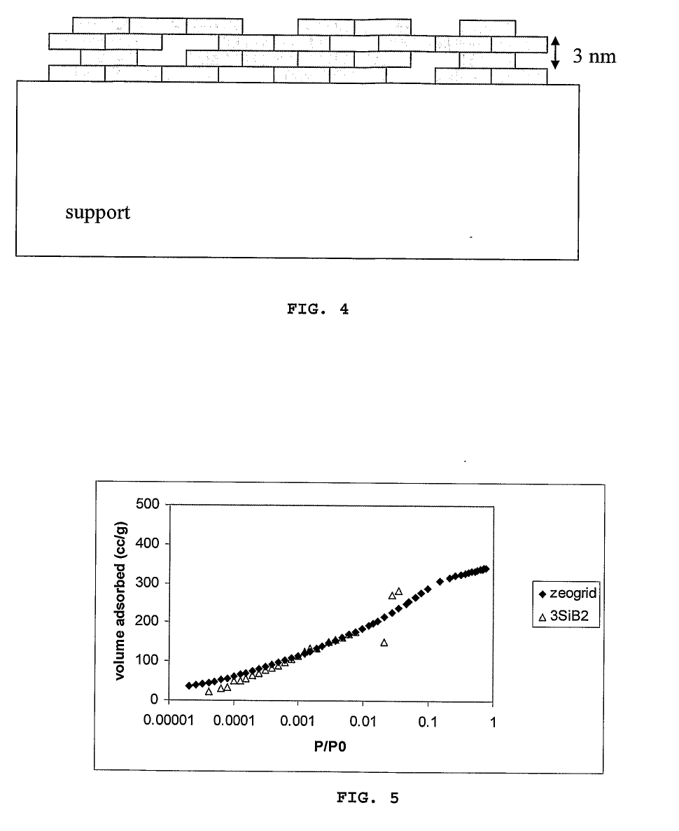

### DESCRIPTION OF THE INVENTION

Key step in the synthesis of the membranes is the ordered stacking of regular nanometre-sized particles having zeolite framework on a support with the help of surfactants and careful calcinations. This zeolite membrane formation does not involve any hydrothermal treatment nor other crystal growth process. The method makes use of the layered stacking of said nano-sized particles mediated by appropriate surfactants as e.g. CTAB or DTAB. Unlike the method described in the state of the art to form micrometre-sized spherical particles (see Kremer et al.), here, only a low amount of surfactant is mixed into the solution of nano-sized particles with zeolite framework, and this in order to prevent the formation of any or too large layered particles in the solution. The low amount of surfactant leads only to sufficient ordered layering of the building blocks when the solution is concentrating while brought in contact with a porous support. The contact with a porous support leads to a concentration of the solution due to the removal of solvent from the solution through capillary forces, a procedure that is known in the art of forming porous ceramic membranes by the sol-gel method. The ordered layering leads preferably to an ideal or close to ideal layering of the used building blocks parallel to the surface of the support, with possible interparticle voids between the layering particles after removal of the surfactant (see FIG. 4). In this preferable case, after calcination to remove the surfactant and the TPA molecules, all molecules approaching the so-formed zeolite-like membrane layer, penetrate the membrane by the microporous zeolite pores of the nano-sized building blocks. The super-micropores created by empty spaces between stacked nano-sized particles are only reached after passing the microporous zeolite pores, and therefore do not decrease the selectivity of the new membrane.

The same method of layered stacking of the nano-sized particles having zeolite framework may also be applied to a non-porous support, such as e.g. a silicon wafer. This is useful for e.g. altering the surface and material properties of the (non-porous) support and for adsorption applications.

Following the description above, the new method gives rise to membranes with zeolite-like properties. When using different nano-sized building blocks, having the framework of different zeolites, membranes with different zeolite-like properties can be formed. Moreover, using the ion-exchange capacities of the zeolites and therefore also of the nano-sized building blocks having zeolite framework, catalytically active zeolite-like membranes are also in reach.

The method to form such a zeolite-like membrane using nano-sized particles with zeolite framework, comprises the following steps:
a. A solution of nano-sized particles with zeolite framework is mixed with a solution of an appropriate surfactant as e.g. CTAB,
b. A porous support, pretreated or not, is brought into contact with the diluted mixture e.g. by dip-coating or by spin-coating,
c. The coated support is dried carefully, preferably during 1 to 5 days,
d. The dried, coated support is calcined in order to remove properly the surfactant and the TPA from the nano-sized particles.

According to a specific embodiment, between steps a and b, the mixture may be subjected to an ageing step followed by a dilution step. The ageing step is applied preferably with a duration of between 1 hour and 30 days.

The porous support that is used in step d. of the method according to the invention preferably consists of an inorganic material. A multilayer ceramic support with an alumina and/or zirconia and/or titania base or a composition thereof, is a suitable support. Other materials of the type indicated below, or combinations/compositions thereof, may also be suitable: carbon, silica, zeolites, clays, glass and metal (stainless steel, silver). All of the geometries may be suitable for the support, for example, tubular, flat, in the form of disks, sheets, single or multichannel tubes, fibres or hollow fibres.

For the porous support, a broad range of pore sizes can be used. In order to use the support untreated, a support with its smallest pores <20 nm, and preferably <4 nm, is preferably chosen. For instance, a multilayer porous support consisting of an UF (Ultra-filtration) alumina/titania membrane with top-layer pores of 50 nm coated with one or two extra titania or zirconia layers with pores of about 3 nm, is a suitable support for coating without pre-treatment. With pre-treatment, porous supports with their smallest pores much larger than 20 nm can be used, as for example UF or MF (Micro-filtration) multilayer metaloxide membranes with top-layer pores of 50 to 200 nm. In this case, as pretreatment, different methods to prevent suction of the nano-sized particles of the coating solution in the pore structure of the support can be used, including but not limited to impregnation with water, wax or any other pore-filling organic.

In step d. of the method according to the invention, a non-porous support may equally be used, such as e.g. a silicon wafer.

The new methodology offers several advantages over the classical synthesis routes for zeolite membranes. At first, it is a very simple synthesis procedure, avoiding the technically demanding hydrothermal treatment of the classical synthesis routes. Secondly, due to the real nano-size of the building blocks (1.3×2×4 nm³ or small multiples thereof for the case of silicalite-1 membranes) very thin zeolite-like membranes can be formed, having very high mass transport i.e. high flux. Moreover the small thickness reduces strongly the risk to create cracks in case of thermal cycling of the formed membranes. This is another clear advantage of the newly developed membranes compared to the state-of-the-art zeolite membranes. Thirdly, the building blocks in the innovative membranes are only systematically ordered during the membrane synthesis, without any further crystallization or particle growth. Therefore, this new synthesis method has great potential to avoid the formation of less-selective or non-selective interparticle voids accessible by molecules entering the membrane, as is inevitably the case for the zeolite membranes known to the art. This gives the new membranes at least equal but most likely extra high selectivity. These three advantages show that the present invention, clearly has the potential to lead to membranes combining high flux and high selectivity.

Due to the absence of a hydrothermal step in the method of the invention, crystallization or particle growth does not occur among the nano-sized building blocks.

The new zeolite-like membranes, being a systematically ordered stacking of the used nano-sized particles, unaltered by the synthesis, do not show any zeolite-like high-angle Bragg-type XRD diffraction pattern. This makes them clearly distinguishable from the state-of-the-art zeolite membranes.

For silicalite-1 like membranes the zeolite-like microporosity lies in between 0.10 and 0.20 cm³/g and is typically about 0.14 cm³/g, while the super-microporosity lies typically between 0.3 and 0.6 cm³/g.

It is important to note that, while the zeogrid spherical particles as disclosed by Kremer et al. are a powder material which may be used in batch-like filter processes, the membrane of the present invention is coated on a support. Surprisingly, the low amount of surfactant used in the synthesis of the membrane allows to achieve a good control on coating thickness and uniformity.

The new zeolite-like membranes can be used in the same applications as the state-of-the-art zeolite membranes. Possible applications include but are not limited to pervaporation, gas separation and/or catalytic reactions. The new methodology has great potential to lead to membranes with never seen high performance.

Following the new methodology a microporous zeolite-like film was made on a silicon wafer. N₂-adsorption on the silicon supported film revealed the same dual porosity as was seen for the zeogrid powder described above (see FIG. 5). Both zeolite-like micropores and super-micropores are the same as for the zeogrid powder. FIG. 6 showing the low-angle XRD pattern of the silicon supported film, reveals a peak around 3 nm, proving the layered stacking of the nano-sized building blocks, previously seen for the zeogrid powder. High-angle Bragg-type XRD diffraction is absent.

### Example 1

A zeolite-like membrane on porous support was formed following the different steps of the procedure mentioned above:
a. A solution of nano-sized particles with silicalite-1 framework was prepared through hydrolysis of tetraethyl ortho-silicate (91.43 g), commercially available form Acros, 98% purity) in 80.24 g of an aqueous tetrapropylammonium hydroxide solution (40% by weight concentration) under stirring. After hydrolysis, 78.33 g water was added and stirring continued for 24 hours. The size of the nano-sized particles (dimensions of 1.3×2.0×4.0 mm³ in this embodiment) is controlled by synthesis conditions. 5 ml of this solution of nano-sized silicalite-1 particles is diluted with 15 ml of ethanol. Subsequently, 2 ml of a 10 wt % solution of the surfactant dodecyltrimethylammonium bromide (DTAB, commercially available from Acros, 99% purity) in ethanol is added to the diluted nanoslab solution under continuous stirring for 5 minutes. This means that per volume of nanoslab solution, 0.4 volume of 10 wt % surfactant solution in ethanol is used, and 3 volumes of diluting ethanol. In this mixture the surfactant concentration is much lower than the concentration used to produce zeogrid powder: according to prior art zeogrid is produced using per volume of nanoslab solution, 3 volumes of 12 wt % surfactant solution in ethanol, and 0 to maximum 1 volume of diluting ethanol.
b. The mixture is aged for 8 days
c. The mixture is diluted with ethanol to a ratio of 1:25. In the coating mixture, the surfactant concentration is 0.036 wt %.
d. A porous support in the form of a disk of 2.5 cm diameter and 2 mm thickness, is dip-coated in the diluted mixture. The support is a multilayer dense UF membrane consisting of a home-made porous alpha-alumina substructure with pores of 100 nm, coated with two mesoporous titania layers. The toplayer pores measured about 3 nm. The molecular weight cut-off of the support was checked to be about 4000 Dalton. The porous support was used without pretreatment.
e. The coated support was dried carefully during 2 days at room temperature
f. The dried, coated support is calcined for 4 hours at 425° C. (temperature increase of 10° C./hour) to remove the surfactant and the TPA form the nano-sized silicalite-1 particles.

It was found that the quality of the coated zeolite-like membrane layer could not be checked by N₂ adsorption and low-angle XRD measurements as in the case for the zeolite-like film on silicon wafer described above, due to the high background signals of the porous support. Therefore, as an alternative quality test, the membrane was checked for its nanofiltration performance of small PEG molecules with molecular weights between 200 and 1500 Dalton. It is known that a glucose molecule of 180 Dalton measures 0.7 nm (PhD thesis Bart Van der Bruggen, K. U. Leuven, 2002). Therefore a defect-free silicalite-1 like membrane prepared by the new methodology, having only silicalite-1 pores of 0.5 nm available for molecules entering the membrane, must show a 100% retention for all used PEG molecules.

In practice, the membrane was mounted in a small cross-flow filtration unit containing a solution of RO water with 1 g/l of PEG molecules with molecular weight of 1500 Dalton, 1 g/l of PEG molecules with molecular weight of 600 Dalton, and 1 g/l of PEG molecules with molecular weight of 200 Dalton (the PEG molecules are commercially available from Acros). The transmembrane pressure was set to 10 bar. After 24 hours, no single droplet was collected at the permeate side, proving the absence of pores bigger than 0.5 nm. As no permeate could be collected, no retention of the different PEG molecules could be derived.

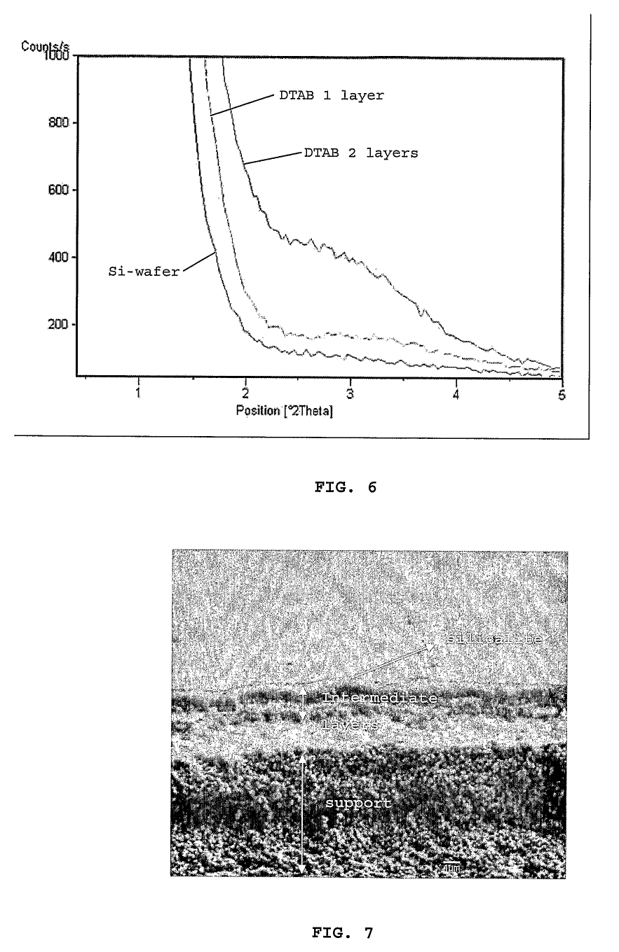

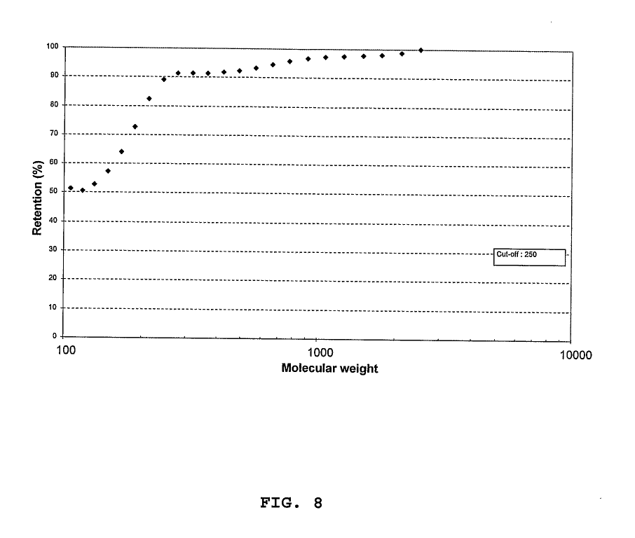

The membrane of this example was also analysed by SEM. FIG. 7 shows the high quality of the membrane layer, revealing no visual defects. The thickness of the membrane layer is estimated to be about 100 nm.

### Example 2

Another zeolite-like membrane on porous support was formed following the different steps of the procedure mentioned above:
a. A solution of nano-sized particles with silicalite-1 framework was prepared in the same way as described in example 1. 5 ml of this nanoslab solution is diluted with 15 ml of ethanol. Subsequently, 3 ml of a 10 wt % solution of the surfactant dodecyltrimethylammonium bromide (DTAB, commercially available from Acros, 99% purity) in ethanol was added to the diluted nanoslab solution under continuous stirring for 5 minutes. In this example per volume of nanoslab solution, 0.6 volume of 10 wt % surfactant solution in ethanol is used, and 3 volumes of diluting ethanol. The surfactant concentration is again much lower than the concentration used to produce zeogrid powder (see example 1).
b. The mixture is aged for 6 days.
c. The mixture is diluted with ethanol to a ratio of 1:20. In the coating mixture, the surfactant concentration is 0.063 wt %.
d. A porous support in the form of a single tube of 1.0 cm outer diameter and 12 cm length, is dip-coated in the diluted mixture. The support is a multilayer dense UF membrane consisting of a commercially available open UF membrane with porous alpha-alumina substructure and titania toplayer with pores of 60 nm (commercially available from Inocermic gmbh), home-coated with two mesoporous titania layers. The toplayer pores measured about 3 nm. The molecular weight cut-off of the support was checked to be about 4000 Dalton. The porous support was used without pretreatment.
e. The coated support was dried carefully during 2 days at room temperature
f. The dried, coated support is calcined for 4 hours at 425° C. (temperature increase of 10° C./hour) to remove the surfactant and the TPA form the nano-sized silicalite-1 particles.

The quality of the coated zeolite-like membrane layer was again checked by nanofiltration with small PEG molecules with molecular weights between 200 and 1500 Dalton. As in example 2, the membrane was mounted in a small cross-flow filtration unit containing a solution of RO water with 1 g/l of PEG molecules with molecular weight of 1500 Dalton, 1 g/l of PEG molecules with molecular weight of 600 Dalton, and 1 g/l of PEG molecules with molecular weight of 200 Dalton (the PEG molecules are commercially available from Acros). The transmembrane pressure was set to 5 bar. A small permeate flux of 3 l/hm²bar was measured. The permeate and the retentate of the filtration was analysed by gel permeation chromatography, and showed 90% retention for a molecular weight of 250 Dalton. As explained above, this proves the low amount of defect-pores remaining in the membrane layer. The retention curve is shown in FIG. 8.

1. A silicate-based microporous ceramic molecular sieve membrane with zeolite-like properties, the membrane comprising a support and a membrane layer coated on a surface of said support, and wherein said membrane layer comprises nanometre-sized slab-shaped building blocks having zeolite framework and does not comprise any zeolite crystals.

2. The membrane according to claim 1, wherein said building blocks are arranged in a layered stack on said surface.

3. The membrane according to claim 1, wherein the membrane layer comprises super-micropores in between the building blocks and the building blocks comprise zeolite-like micropores.

4. The membrane according to claim 1, wherein the building blocks have a size smaller than 10 nanometre.

5. A method of coating a silicate-based layer onto a support, the method comprising the steps of:
a. mixing a solution comprising nanometre-sized slab-shaped building blocks having zeolite framework and an appropriate surfactant,
b. coating the support with this mixture, the concentration of said surfactant in said mixture during coating lying in the range between 0.01 and 1 wt %,
c. drying and calcining the coated support.

6. The method according to claim 5, further comprising the step of ageing said mixture, said ageing step to be performed between steps a and b.

7. The method according to claim 6, wherein said ageing step lasts between 1 hour and 30 days.

8. The method according to claim 6, wherein the ageing step comprises the step of diluting said mixture.

9. The method according to claim 5, further comprising the step of subjecting the support to a pre-treatment.

10. The method according to claim 5, wherein said building blocks have a size smaller than 10 nm.
